(19) United States
(12) Patent Application Publication
(10) Pub. No.: US 2004/0205804 A1
(43) Pub. Date: Oct. 14, 2004

(54) Flips 2

(76) Inventor: Leonard B. Curry, Suitland, MD (US)

Correspondence Address: Leonard Bell Curry, 4620 Lacy Avenue, Suitland, MD, 20746-1504, US

(21) Appl. No.: 10/385,081

(22) Filed: Mar. 11, 2003

(51) Int. Cl. G11B 3/70; G11B 5/84; G11B 7/26

(52) U.S. Cl. 720/718

(57) ABSTRACT

The idea here is to have more writing and imprinting space on 3.5, zip diskettes and CD Rom, DVD disk by allowing them to be flipped over to use their other sides.

### RELATED APPLICATION

N/A

### FEDERALLY SPONSORED

N/Y

### MICROFICHE APPENDIX

N/Y

Background of the Invention is space on 3.5 and zip diskettes, CD Rom and DVD disks and all the formats there of past, present and future.

Brief Summary of the Invention is to allow for both sides of the 3.5 and zip diskettes and CD Rom and DVD disks to be used.

### THE VIEW

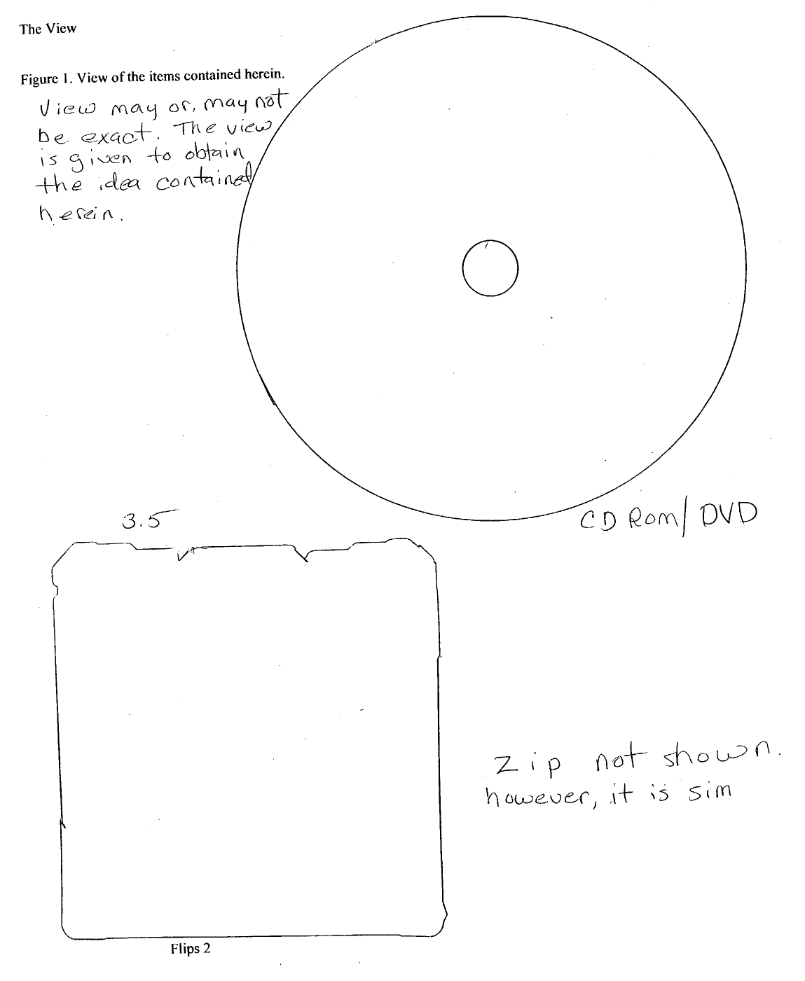

FIG. 1. View of the idea of the idea contained herein.

Detailed Description of the Invention pertains to make in any country in a factory for people to use for storage etc.

This new idea is for people to have more writing/burning storage space on their 3.5 disks and zip diskettes and CD Rom and DVD disks being in whatever format these items may involve being past, present, future. The idea here is simply to allow for more room for writing and storage space, which could involve small to very large size text, music, movie items, and text files, etc. All anyone would have to do is to flip these said items over to have more writing, imprinting space. The 3.5 diskettes and the zip diskettes would have to be modified to be of a mirror image because the machines A: and zip drives wont except the diskettes flipped over on the opposed sides. I suppose the machines could be modified, or new ones made with the implied new modification as to except the diskettes as they are. However, in respect to cost it would be cheaper to make new modified diskettes. Hence the idea for Flips. The CD Rom and the DVD disks would only have to be made to be writ able on both sides, not just the one side as they are now. This would allow for more then one type of format on one disk. There could be music on one side and movies on the other. These disk would store whatever anyone might want to put onto them.

Sequence Listing: Materials used in making CD-ROM's, DVD's disks, 3.5 diskettes, Zip Diskettes. Plastic, metal etc.

1. I Leonard Bell Curry do hereby make claim to the idea contained within this letter, called Flips 2. The idea to Flips is to allow for more space for writing, burning/imprinting what have they onto 3.5 diskettes and zip diskettes and CD Rom and DVD disks. This will be done by simply modifying the 3.5 and zip diskettes as to flip them over allowing for both sides to be written on. And removing the labels etc, off of the CD Rom and DVD disks and formatting that side to also be writ able to except items such as movies, music, still photos, text files, programs anything and everything that a person, company would want and need to store and keep.
